(19) United States
(12) Patent Application Publication
(10) Pub. No.: US 2025/0223431 A1
(43) Pub. Date: Jul. 10, 2025

(54) AQUEOUS DISPERSION OF BIOCIDE-FREE ORGANIC OPACIFYING PIGMENT PARTICLES

(71) Applicant: Rohm and Haas Company, Collegeville, PA (US)

(72) Inventors: Tara L. Conley, Chalfont, PA (US); Erica A. Frankel, Audubon, PA (US); Michael W. Leonard, Collegeville, PA (US); Benjamin Reiner, Collegeville, PA (US); Vladislav V. Telyatnikov, Eagleville, PA (US); Arnold S. Brownell, Lansdale, PA (US)

(21) Appl. No.: 18/846,765

(22) PCT Filed: Mar. 23, 2023
(86) PCT No.: PCT/US2023/016100

§ 371 Date: Sep. 13, 2024

Related U.S. Application Data
(60) Provisional application No. 63/324,752, filed on Mar. 29, 2022.

(51) Int. Cl. C08L 25/14; C08L 33/06

(52) U.S. Cl. CPC C08L 25/14; C08L 33/064; C08L 2207/53

(57) ABSTRACT

The present invention relates to a composition comprising an aqueous dispersion of multistage polymer particles comprising a water-occluded core and a polymeric shell having a Tg in the range of from 60° C. and 120° C.; a preservative amount of either t-C4-C10-alkyl hydroperoxide or hydrogen peroxide; and less than 1000 ppm of residual monomer. The present invention addresses a need in the art by providing a way to preserve opaque polymers against microbial contamination without the use of a biocide.

### BACKGROUND OF THE INVENTION

The present invention relates to an aqueous dispersion of organic opacifying pigment particles that exhibit resistance to microbial growth in the absence of a biocide.

Waterborne intermediates used in the coatings industry are preserved with antimicrobial agents to inhibit the formation and growth of biological organisms such as bacteria, yeast, and mold while in storage. Inhibition of these organisms prevents product degradation and spoilage, as well as off-gassing of volatile products and consequent pressure build-up in closed containment. Preservation is therefore essential for reasons of health, safety, and performance.

In-can preservatives such as isothiazolinones are facing intense regulatory scrutiny for their real or perceived adverse impact on health, safety, and the environment; in fact, an outright ban of these biocides in many parts of the world appears in the offing. Inasmuch as the development of new biocides is unlikely for reasons of cost and a widespread perception, justified or not, of their inherent dangers, a need exists to supplant biocides with alternative non-biocidal preservatives that are safer and more sustainable.

A recent example of a non-biocidal approach for preserving paints against microbial contamination can be found in EP 3 456 787 B1, which discloses a water-borne coating formulation adjusted to a pH in the range of 10 to 12.5. While ostensibly effective, these very high pH formulations create additional safety and health concerns that render this approach impractical. Other non-traditional approaches such as the addition of silver or zinc ions may adversely affect the properties of the paint and face regulatory scrutiny as well. For these reasons, other safer and more sustainable approaches for preserving paints and paint additives are needed.

### SUMMARY OF THE INVENTION

The present invention addresses a need in the art by providing a composition comprising
a) an aqueous dispersion of multistage polymer particles comprising:
   1) a water-occluded core comprising from 20 to 60 weight percent structural units of a salt of a carboxylic acid monomer and from 40 to 80 weight percent structural units of a nonionic monoethylenically unsaturated monomer; and
   2) a polymeric shell having a Tg in the range of from 60° C. and 120° C.;
b1) from 500 ppm to 5,000 ppm of a t-C4-C10-alkyl hydroperoxide, based on the weight of the composition; or
b2) from 1000 ppm to 10000 ppm of hydrogen peroxide and from 50 ppm to 1000 ppm of a chelating agent that is not complexed with a multivalent metal cation, based on the weight of the composition; and
c) less than 1000 ppm of residual monomers, based on the weight of the composition;
wherein the z-average particle size of the polymer particles is in the range of from 300 nm to 2000 nm.

The present invention addresses a need in the art by providing a way to preserve opaque polymers against microbial contamination without the use of a biocide.

### DETAILED DESCRIPTION OF THE INVENTION

The present invention is a composition comprising
a) an aqueous dispersion of multistage polymer particles comprising:
   1) a water-occluded core comprising from 20 to 60 weight percent structural units of a salt of a carboxylic acid monomer and from 40 to 80 weight percent structural units of a nonionic monoethylenically unsaturated monomer;
   2) a polymeric shell having a Tg in the range of from 60° C. and 120° C.;
b1) from 500 ppm to 5,000 ppm of a t-C₄-C₁₀-alkyl hydroperoxide, based on the weight of the composition; or
b2) from 1000 ppm to 10000 ppm of hydrogen peroxide and from 50 ppm to 1000 ppm of a chelating agent that is not complexed with a multivalent metal cation, based on the weight of the composition; and
c) less than 1000 ppm of residual monomers, based on the weight of the composition;
wherein the z-average particle size of the polymer particles is in the range of from 300 nm to 2000 nm.

The water-occluded core comprises from 20, preferably from 25, more preferably from 30, and most preferably from 32 weight percent, to 60, preferably to 50, more preferably to 40, and most preferably 36 weight percent structural units of a salt of a carboxylic acid monomer based on the weight of structural units of monomers in the core.

As used herein, the term “structural units” refers to the remnant of the recited monomer after polymerization. For example, a structural unit of a salt of methacrylic acid, where M⁺ is a counterion, preferably a lithium, sodium, or potassium counterion, is as illustrated:

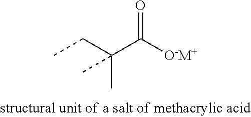

Examples of suitable carboxylic acid monomers include acrylic acid, methacrylic acid, itaconic acid, and maleic acid.

As used herein, “residual monomers” refer to monomers used to prepare the polymer particles that remain unreacted.

The water-occluded core further comprises from 40, preferably from 50, more preferably from 55, more preferably from 60, and most preferably from 64 weight percent to 80, preferably to 75, more preferably to 70, and most preferably to 68 weight percent structural units of a nonionic monoethylenically unsaturated monomer based on the weight of structural units of monomers in the core. Examples of nonionic monoethylenically unsaturated monomers include one or more acrylates and/or methacrylates such as methyl acrylate, ethyl acrylate, n-butyl acrylate, t-butyl acrylate 2-ethylhexyl acrylate, methyl methacrylate. n-butyl methacrylate, t-butyl methacrylate, isobutyl methacrylate, isobornyl methacrylate, lauryl methacrylate, and cyclohexyl methacrylate; and one or more monoethylenically unsaturated aromatic compounds such as styrene, α-methylstyrene, and 4-t-butylstyrene. A preferred nonionic monoethylenically unsaturated monomer is methyl methacrylate.

The polymeric shell of the polymer particles preferably has a T_{g} in the range of not less than 60° C., or not less than 80° C., or not less than 90° C., or not less than 95° C., and not greater than 115° C., or not greater than 110° C. As used herein, T_{g} refers to the glass transition temperature as calculated by the Fox equation, using homopolymer T_{g} data reported in Polymer Handbook 4th Edition (1999, John Wiley & Sons, Inc.).

Preferably, the shell of the polymer particles comprises structural units of methyl methacrylate, styrene, α-methylstyrene, isobornyl methacrylate, lauryl methacrylate, or cyclohexyl methacrylate. In one embodiment, the shell comprises at least 80, or at least 90, or at least 95 weight percent structural units of styrene. In another embodiment, the shell comprises from 89 to 93 weight percent structural units of styrene and from 7 to 11 weight percent structural units of any or all of methyl methacrylate (4 to 5 weight percent), cyclohexyl methacrylate (0.9 to 2 weight percent), methacrylic acid (2 to 3 weight percent), and the multiethylenically unsaturated monomer, allyl methacrylate (ALMA, 0.1 to 0.5 weight percent).

The polymeric shell may also further comprise structural units of other multiethylenically unsaturated monomers such as divinyl benzene (DVB), trimethylolpropane trimethacrylate (TMPTMA), or trimethylolpropane triacrylate (TMPTA). The solids content of the multistage polymer particles is preferably in the range of 10 to 40 weight percent, based on the weight of the composition.

In one aspect, the z-average particle size of the polymer particles is preferably in the range of from 950 nm to 2000 nm; in another aspect, the z-average particle size of the polymer particles is in the range of from 200 nm, preferably from 350 nm, and more preferably from 375 nm, to preferably 600 nm, more preferably to 500 nm, and most preferably to 425 nm. As used herein, z-average particle size refers to particle size as determined by dynamic light scattering, for example by a BI-90 Plus Particle Size Analyzer (Brookhaven). The multistage polymer particles preferably comprise from 10 to 35 weight percent of the composition.

The composition also comprises a C₄-C₁₀-t-alkyl hydroperoxide or hydrogen peroxide. Preferably the t-C₄-C₁₀-alkyl hydroperoxide is a t-C₄-C₈-alkyl hydroperoxide, more preferably t-butyl hydroperoxide or t-amyl hydroperoxide or a combination thereof at a concentration in the range of from 500 ppm, or from 600 ppm, or from 700 ppm, or from 1000 ppm to 10000 ppm, or to 5000 ppm, or to 3000 ppm. When the composition comprises hydrogen peroxide only, the composition further comprises a chelating agent that is not complexed with a multivalent metal such as iron.

Examples of suitable chelating agents include diaminocarboxylic acid salts such as the tetrasodium salt of ethylenediaminetetraacetic acid (EDTA tetrasodium salt), commercially available as VERSENE™ Chelating Agent (A Trademark of The Dow Chemical Company or its Affiliates), and hydroxyethylidene diphosphonic acid salts such as the tetrasodium salt of 1-hydroxy ethylidene-1,1-diphosphonic acid, commercially available as DeQuest 2016 Chelating Agent.

The aqueous dispersion of multistage polymer particles can be prepared, for example, by methods disclosed in U.S. Pat. No. 6,020,435 and US 2020/0071439 A1. Examples of commercially available dispersions of first multistage polymer particles include ROPAQUE™ Ultra Opaque Polymers, AQUACell HIDE 6299 Opaque Polymers, and ROPAQUE™ TH-2000 Hollow Sphere Pigments. (ROPAQUE is a Trademark of The Dow Chemical Company or its Affiliates.)

As disclosed in U.S. Pat. No. 6,020,435, the dispersion of multistage polymer particles is prepared by sequential emulsion polymerization. In this process, an aqueous dispersion of core polymer particles is first contacted with a monomer, the homopolymer of which has a calculated T_{g} in the range of from 60° C., or from 80° C., or from 90° C., or from 95° C., to 115° C., or to 110° C. under emulsion polymerization conditions to form an aqueous dispersion of core/shell or core/intermediate polymer particles.

In a second step, a free radical chaser is added to the reaction mixture to inhibit polymerization of subsequently added swelling monomer. Examples of suitable free radical chasers include an oxidizable metal salt such as FeSO₄, which is rendered water-soluble at high pH by forming a water-soluble complex with a chelating agent such as EDTA tetrasodium salt. The chelating agent is used as a limiting reagent in this step.

Following the addition of the free radical chaser, a swelling monomer, the homopolymer of which has a T_{g} in the range of from 60° C., or from 80° C., or from 90° C., to 120° C., or to 110° C., and a polymerization inhibitor are added to the reaction mixture. In one aspect, the swelling monomer comprises at least 80 or at least, or at least 90, or at least 95 weight percent styrene.

In another aspect, the swelling monomer comprises from 89 to 93 weight styrene and from 7 to 11 weight percent of any or all of methyl methacrylate (4 to 5 weight percent), cyclohexyl methacrylate (0.9 to 2 weight percent), methacrylic acid (2 to 3 weight percent), and the multiethylenically unsaturated monomer, allyl methacrylate (ALMA, 0.1 to 0.5 weight percent). Examples of polymerization inhibitors include 4-hydroxy-2,2,6,6, tetramethylpiperidinyloxy, free radical (4-hydroxy-TEMPO), hydroquinone, p-methoxyhydroquinone, t-butyl-p-hydroquinone, and 4-t-butyl catechol.

After the addition of the swelling monomer and the polymerization inhibitor is complete, a swelling agent is added to the aqueous dispersion of multistage polymer particles to penetrate the shell or intermediate layer and induce swelling of the core with water. The swelling agent is a base such as ammonium hydroxide, LiOH, NaOH, and KOH. Next, in the critical step of one aspect of the process of the present invention, a C₄-C₁₀-t-alkyl hydroperoxide, preferably a C₄-C₁₀-t-alkyl hydroperoxide, and more preferably t-butyl hydroperoxide or t-amyl hydroperoxide and a reductant such as isoascorbic acid are added to the aqueous dispersion, at a mole-to-mole ratio of C₄-C₁₀-t alkyl hydroperoxide to reductant in the range of from 5:1, or from 7.5:1, or from 12:1; to 50:1, or to 30:1, or to 20:1. This ratio is considerably higher than previously reported ratios, which are in the range of 2.0:1 to 3.0:1, and therefore considerably higher than what is required to chase residual monomer. To be clear, there is no obvious reason to add more oxidant than what is taught to be sufficient to chase residual monomer.

Preferably, the t-alkyl hydroperoxide is added in a single shot, followed by gradual addition of the reductant. It also may be advantageous to add a portion of the t-C₄-C₁₀-alkyl hydroperoxide in a single shot prior to the addition of the reductant, then add the remainder of the t-C₄-C₁₀-alkyl hydroperoxide after completion of addition of the reductant. For example, 1235 ppm t-butyl hydroperoxide can be added to the dispersion in a single shot, followed by gradual addition of 305 ppm of isoascorbic acid; alternatively, 412 ppm of t-butyl hydroperoxide can be added to the dispersion in a single shot, followed by gradual addition of 305 ppm of isoascorbic acid, followed by the addition, 823 ppm of t-butyl hydroperoxide. After the completion of isoascorbic acid addition, 823 ppm of t-butyl hydroperoxide can be added.

When hydrogen peroxide and a chelating agent are used, the redox coupling agent is added at a ratio in the range of 2.0:1 to 3.0:1 and a combination of hydrogen peroxide and a chelating agent that is not complexed with a metal ion such as Fe⁺² is post-added. In this aspect, the amount of added hydrogen peroxide is in the range of 0.1 to 1 weight percent, based on the weight of the composition, and the added amount of chelating agent not complexed with a metal cation is in the range of from 50 ppm to 1000 ppm, based on the weight of the composition.

In addition to accomplishing the goals of reinitiating polymerization and chemically converting the amount of unreacted monomer from a level generally in the range of 8 to 20 weight percent, based on the weight of multistage polymer particles and the unreacted monomer, to levels below 1000 ppm, preferably below 500 ppm, the presence of a marked excess of the class of oxidant described herein creates an opaque polymer composition that is resistant to microbial attack. Conversely, when conventional amounts of t-butyl hydroperoxide described in the art are used (mole: mole ratios in the range of from 2.0:1 to 3.0:1 with respect to isoascorbic acid with no post addition of hydrogen peroxide and chelating agent) the resultant concentration of t-butyl hydroperoxide (˜350 ppm) is insufficient to act as a preservative when the final concentration of unreacted monomer at less 1000 ppm.

It has been discovered that adding a 1-C₄-C₁₀-alkyl hydroperoxide in large excess of what is traditionally added for the purposes of chemically converting monomer to become part of the shell of the multistage polymer particles preserves the substantially monomer free dispersion of multistage polymer particles against microbial attack. More particularly, adding t-butyl hydroperoxide or t-amyl hydroperoxide after the swelling step at a mole: mole ratio of oxidant to reductant of at least 5:1, or at least 7.5:1, or at least 12:1; and preferably not greater than 50:1, or 30:1, or 20:1, gives excellent preservative properties without the need for a biocide. As previously noted, the excess oxidant need not be added all at once. It is also possible to add approximately the same amount of oxidant that is historically used in the post-swelling monomer chase step, followed by a post-addition of a preservative amount of oxidant after completion of the chase.

The additional chelating agent that provides preservative capabilities (where H₂O₂ is the oxidant) or improved preservative capabilities (under some circumstances where the 1-C₄-C₁₀-alkyl hydroperoxide is the oxidant) is higher than the amount required to complex with any free (non-complexed) metal cation. Preferably, the non-complexed chelating agent concentration is in the range of from 100 ppm to 2000 ppm based on the weight of the composition.

It has been discovered that preservation of aqueous dispersions of opaque polymers can be achieved at a relatively low pH, typically from 7.5 or from 8.0 to 9.5 or to 9.0; it has also been discovered that preservation comparable to what is achieved with biocides can be achieved at a relatively low pH without any biocides. Accordingly, in another aspect, the composition of the present invention comprises an absence of any biocide.

Disclosed methods describe the use of a stoichiometric excess of the metal salt, leaving no residual chelating agent that is not complexed with the metal salt. It has been discovered that the presence of a sufficient amount of additional chelating agent is necessary to achieve a preservative effect when hydrogen peroxide is used, and sometimes beneficial for improving preservation when a t-C₄-C₁₀-alkyl hydroperoxide is used.

### EXAMPLES

¹H NMR Spectroscopic Determination of t-AHP or t-BHP in Serum Phase

A ˜ 10-mL polycarbonate tube was charged with 3.0 mL of a latex sample and 3.0 mL of Milli-Q water, and centrifuged at 100,000 rpm for 15 min. The resulting clear supernatant was carefully decanted and transferred into a 5-mm NMR tube. A flame-sealed capillary tube filled with an external standard (5.000 wt % d₄-sodium trimethylsilylpropionate in D₂O) was added to the NMR tube. Careful attention was paid to proper alignment of the external standard within the NMR tube. NMR spectra were obtained using the Bruker AVANCE III 600 spectrometer equipped with a 5-mm BroadBand CryoProbe. Each sample was tuned and shimmed individually but pulse widths and receiver gain were held constant for a sample series. Concentration of free t-amyl hydroperoxide or t-butyl hydroperoxide was measured by using the zg pulse sequence with the following parameters: acquisition time (aq)=2.5 s, recycle delay (d₁)=30 s, number of transients (ns)=1024, receiver gain (rg)=32, and pulsewidth (p1)=11 ms. All other parameters (time domain size, sweep width, dwell time, pre-scan delay, and carrier frequency) were left at the default values. Concentration of free hydroperoxide was calculated by comparing the integrations of peaks resonating around 1.2 ppm and the peak for the external standard at 0.0 ppm. Spectra were referenced to the external standard at 0.0 ppm on the trimethylsilyl chemical shift scale.

### ¹H NMR Spectroscopic Analysis of Hydrogen Peroxide

¹H NMR spectroscopic analysis of H₂O₂ can be determined as described in Quantitative analysis of hydrogen peroxide by 1H NMR spectroscopy, Anal. Bioanal. Chem. (2005), 381:1289-1293.

### Preparation of Samples for Microbial Resistance

Samples were tested for microbial resistance “as-is” (not heat-aged) as well as after being subjected to 50° C. for four-weeks (heat-aged). A 10-g aliquot was taken from each sample and inoculated three times at 7-d intervals with 106-107 colony forming units per milliliter of sample (CFU/mL) of a standard pool of bacteria, yeasts, and molds obtained from American Type Culture Collection (ATCC) that are common contaminants in coatings. Once inoculated, the samples were stored in 25° C. incubators. Test samples were monitored for microbial contamination by agar plating using a standard streak plate method. Samples were plated 1 d and 7 d after each microbial challenge onto trypticase soy agar (TSA) and potato dextrose agar (PDA) plates. All agar plates were checked daily up to 7 d after plating to determine the number of microorganisms surviving in the test samples. Between checks, the agar plates were stored in incubators at 30° C. for TSA plates and at 25° C. for PDA plates. The extent of microbial contamination was established by counting the colonies, where the rating score was determined from the number of microbial colonies observed on the agar plates. Reported results come from day 7 readings, and are summarized for both the “as-is” and heat-aged samples. Table 1 illustrates the rating system used to estimate the level of microbial contamination on streak plates. Colonies refers to the number of colonies on the plate.

TABLE 1
Rating system for estimating microbial contamination

| Colonies | Rating Score | Contamination | Result |
|---|---|---|---|
| None | 0 | None | Pass |
| 1-9 | Tr | Trace | Pass |
| 10 to 99 | 1 | Very Light | Fail |
| 100 to ~1000 | 2 | Light | Fail |
| ~1000 to 10,000 | 3 | Moderate | Fail |
| >10,000 | 4 | Heavy | Fail |

In Table 1, “Pass” means fewer than ten colonies were detected on plates on the specified day (Day 1 (D1) or Day 7 (D7)) after inoculation. “Fail means that ten or more distinct colonies were detected on plates on the specified day after inoculation.

### Comparative Example 1—Preparation of an Aqueous Dispersion of Multistage Polymer Particles

In the following description, Core #1 refers to an aqueous dispersion of polymer particles (66 MMA/34 MAA, solids 32.0%, z-average particle size of 135 nm) prepared substantially as described in U.S. Pat. No. 6,020,435.

A 5-L, four-necked round bottom flask was equipped a paddle stirrer, thermometer, N₂ inlet and reflux condenser. DI water (730.64 g) and acetic acid (0.28 g in 1.64 g water) was added to the vessel and the contents were heated to 89° C. under N₂. Sodium persulfate (NaPS, 3.39 g in 24.55 g water) was added to vessel immediately followed by Core #1 (218.53 g). Monomer emulsion 1 (ME 1), which was prepared by mixing DI water (69.55 g), Polystep A-16-22 emulsifier (5.5 g), styrene (69.95 g), methacrylic acid (8.43 g), and methyl methacrylate (61.53 g), was then added to the vessel over 60 min. The temperature of the reaction mixture was held constant at 78° C. for the duration of the ME 1 feed, after which time a DI water rinse (32.73 g) was added. Upon completion of the ME 1 feed, monomer emulsion 2 (ME 2), which was prepared by mixing DI water (217.64 g), Polystep A-16-22 emulsifier (11.09 g), styrene (657 g), linseed oil fatty acid (4.17 g), allyl methacrylate (2.13 g), and methacrylic acid (12.6 g), was fed to the vessel over 60 min. The temperature of the reaction mixture was allowed to increase to 84° C. after 15 min and allowed to increase to 92° C. after 25 min. Simultaneously with the start of ME 2 feed, a solution of NaPS (0.93 g in 62.18 g water) was cofed to the vessel over 65 min. Upon completion of the ME 2 feed, a DI water rinse (32.73 g) was added to the vessel, followed by addition of an aqueous mixture of ferrous sulfate heptahydrate ((16.36 g of 0.1 wt. % FeSO₄·7H₂O) and VERSENET Chelating Agent (1.64 g of 1 wt. % EDTA tetrasodium salt) was added to the vessel followed by the addition of hot DI water (>60° C., 182.45 g). The contents of the reaction mixture were held at 90-92° C. for 15 min.

ME 3, which was prepared by mixing DI water (57.27 g), Polystep A-16-22 emulsifier (2.05 g), styrene (167.73 g), and 4-hydroxy TEMPO (1.88 g), was fed to the vessel over 5 min and temperature of the reaction mixture was allowed to drop to 85° C. Immediately after the ME 3 feed addition was complete, NaOH (29.45 g, 50 wt. % aq.) mixed with hot DI water (572.73 g) was added to the vessel over 10 min. When NaOH addition was complete, the batch was held for 5 min. Upon completion of the hold, a post-polymerization solution of t-BHP (2.12 g, 70 wt. % aq.) in DI water (24.55 g) was added to the vessel and a separate solution of isoascorbic acid (IAA, 1.1 g) in water (65.45 g) was fed to the vessel over 25 min. Upon completion of addition of the second co-feed, DI water (94.11 g) was added to the vessel and the dispersion was cooled to room temperature and filtered to remove any coagulum. The filtered dispersion had a solids content of 31.0% and the pH was measured to be 8.3. Proton NMR spectroscopic analysis of the serum phase of the sample revealed a t-BHP concentration of <300 ppm.

### Comparative Example 2—Preparation of an Aqueous Dispersion of Multistage Polymer Particles

An aqueous dispersion of multistage polymer particles was prepared substantially as described in Example 1 of U.S. Pat. No. 6,384,104, with the pH being adjusted to 8. Proton NMR spectroscopic analysis of the serum phase of the sample revealed a t-BHP concentration of <350 ppm.

### Example 1

The process was carried out substantially as described in the comparative example, except that upon completion of the hold following NaOH addition, a post-polymerization solution of t-AHP (6.05 g, 85 wt. % aq.) in DI water (24.55 g) was added to the vessel. The filtered dispersion had a solids content of 31.0% and the pH was measured to be 8.3. Proton NMR spectroscopic analysis of the serum phase of the sample revealed a t-AHP concentration of 740 ppm.

### Example 2

The process was carried out substantially as described in the comparative example, except that upon completion of the hold following NaOH addition, a post-polymerization solution of t-BHP (6.36 g, 70 wt. % aq.) in DI water (24.55 g) was added to the vessel. The filtered dispersion had a solids content of 30.3% and the pH was measured to be 8.3. Proton NMR spectroscopic analysis of the serum phase of the sample revealed a t-BHP concentration of 920 ppm.

### Example 3

The process was carried out substantially as described in the comparative example, except that upon completion of the hold following NaOH addition, a post-polymerization solution of t-AHP (10.05 g, 85 wt. % aq.) in DI water (24.55 g) was added to the vessel. The filtered dispersion had a solids content of 29.7% and the pH was measured to be 8.3. Proton NMR spectroscopic analysis of the serum phase of the sample revealed a t-AHP concentration of 1050 ppm.

### Example 4

The process was carried out substantially as described in example 2, except that before filtration and after the dispersion was cooled to <50° C., a solution of Dequest 2016 Chelating Agent (7.2 g, 5 wt. % aq.) was added and mixed for 5 min. The filtered dispersion had a solids content of 30.3% and the pH was measured to be 8.3. Proton NMR spectroscopic analysis of the serum phase of the sample revealed a 1-BHP concentration of 915 ppm.

### Example 5

The process was carried out substantially as described in the comparative example, except that before filtration and after the dispersion was cooled to <50° C., a solution of Dequest 2016 Chelating Agent (1.8 g, 5 wt. % aq.) in DI water (16.36 g) was added to the vessel over 5 min. A solution of hydrogen peroxide (48.48 g, 30 wt. % aq.) in DI water (16.36 g) was then subsequently added to the vessel over 15 min. The dispersion was then filtered to remove any coagulum. The filtered dispersion had a solids content of 29.5% and the pH was measured to be 8.5.

Table 1 shows the heat age challenge test results for the examples. The subscript “o” refers to off the mill (“as is”) challenge tests and the subscript “A” refers to heat-aged challenge tests at seven days.

TABLE 1
Challenge Test Results

| | C1_{∘} | C2_{∘} | C3_{∘} | C1_{Δ} | C2_{Δ} | C3_{Δ} |
|---|---|---|---|---|---|---|
| Comp. 1 | Fail | Fail | Fail | Fail | Fail | Fail |
| Comp. 2 | Fail | Fail | Fail | Fail | Fail | Fail |
| Ex. 1 | Pass | Pass | Pass | Pass | Pass | Fail |
| Ex. 2 | Pass | Pass | Pass | Pass | Pass | Fail |
| Ex. 3 | Pass | Pass | Pass | Pass | Pass | Pass |
| Ex. 4 | Pass | Pass | Pass | Pass | Pass | Pass |
| Ex. 5 | Pass | Pass | Pass | Pass | Pass | Pass |

The data show that t-BHP and t-AHP were effective as preservatives for the aqueous dispersion of opaque polymers. At concentrations three times higher than what was used under normal emulsion polymerization conditions (Comp. 1), a chelating agent was used to achieve efficacy for the third heat-aged challenge test (Example 3). No chelating agent was required for concentrations of the t-alkyl hydroperoxide at five times that of Comp. 1 (Example 4). Hydrogen peroxide was effective in all heat-aged challenge tests in the presence of a chelating reagent.

1. A composition comprising
a) an aqueous dispersion of multistage polymer particles comprising:
1) a water-occluded core comprising from 20 to 60 weight percent structural units of a salt of a carboxylic acid monomer and from 40 to 80 weight percent structural units of a nonionic monoethylenically unsaturated monomer; and
2) a polymeric shell having a T_{g} in the range of from 60° C. and 120° C.;
b1) from 500 ppm to 5,000 ppm of a t-C₄-C₁₀-alkyl hydroperoxide, based on the weight of the composition; or
b2) from 1000 ppm to 10000 ppm of hydrogen peroxide and from 50 ppm to 1000 ppm of a chelating agent that is not complexed with a multivalent metal cation, based on the weight of the composition; and
c) less than 1000 ppm of residual monomers, based on the weight of the composition;
wherein the z-average particle size of the polymer particles is in the range of from 300 nm to 2000 nm.

2. The composition of claim 1 wherein the t-C₄-C₁₀-alkyl hydroperoxide is a t-C₄-C₈-alkyl hydroperoxide at a concentration in the range 600 ppm to 5000 ppm; wherein the water-occluded core comprises from 30 to 50 weight percent structural units of a salt of a carboxylic acid monomer and from 50 to 70 weight percent structural units of a nonionic monoethylenically unsaturated monomer.

3. The composition of claim 2 wherein the t-C₄-C₈-alkyl hydroperoxide is t-butyl hydroperoxide or t-amyl hydroperoxide or a combination thereof; wherein the nonionic monoethylenically unsaturated monomer is methyl methacrylate.

4. The composition of claim 3 wherein the composition comprises from 700 ppm to 3000 ppm t-butyl hydroperoxide and less than 500 ppm of residual monomers.

5. The composition of claim 3 wherein the composition comprises from 700 ppm to 3000 ppm t-amyl hydroperoxide and less than 500 ppm of residual monomers.

6. The composition of claim 2 which further comprises a non-complexed chelating agent at a concentration in the range of from 100 ppm to 2000 ppm based on the weight of the composition.

7. The composition of claim 1 wherein the composition comprises from 1000 ppm to 10000 ppm of hydrogen peroxide and from 50 ppm to 1000 ppm of a chelating agent that is not complexed with a metal cation, based on the weight of the composition.

8. The composition of claim 1 which has a pH in the range of from 7.5 to 9.5.

9. The composition of claim 1 which has a pH in the range of from 8.0 to 9.0.

10. The composition of claim 1 wherein the multistage polymer particles have a solids content in the range of from 10 to 40 weight percent, based on the weight of the composition.

11. The composition of claim 3 wherein the composition comprises from 1000 ppm to 3000 ppm t-amyl hydroperoxide and less than 500 ppm of residual monomers.

12. The composition of claim 3 wherein the composition comprises from 1000 ppm to 3000 ppm t-butyl hydroperoxide and less than 500 ppm of residual monomers.
